(19) United States
(12) Patent Application Publication
(10) Pub. No.: US 2005/0067052 A1
(43) Pub. Date: Mar. 31, 2005

(54) Alloy for use in bonded magnet, isotropic magnet powder and anisotropic magnet powder and method for production thereof, and bonded magnet

(76) Inventors: Yoshimobu Honkura, Aichi-ken (JP); Norihiko Hamada, Aichi-ken (JP); Chisato Mishima, Aichi-ken (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/204,426

(22) PCT Filed: Jun. 28, 2002
(86) PCT No.: PCT/JP02/06548

(51) Int. Cl. H01F 1/055

(52) U.S. Cl. 148/105; 148/301

(57) ABSTRACT

An alloy for bonded magnet alloy of the present invention includes at least Fe as a main component, 11-15 at % rare-earth element (R) that includes yttrium (Y) and does not include lanthanum (La), 5.5-10.8 at % B and 0.01-1.0 at % La, and has superior corrosion resistance. Using the obtained magnet powder by applying the d-HDDR process etc. to this bonded magnet, bonded magnet with not only magnetic properties but also reliability such as corrosion resistance and heat resistance etc., can be achieved.

### TECHNICAL FIELD

This invention comprises the alloy for bonded magnet, the isotropic magnet powder as well as anisotropic magnet powder form which a bonded magnet with superior time-variation properties such as magnetic characteristics and corrosion resistance, and their production method, as well as the bonded magnet with superior magnetic characteristics and time-variation properties.

### BACKGROUND ART

Hard magnets (permanent magnet) are used in motors and various other equipment and they are demanded to possess superior magnetic characteristics to achieve the miniaturization and high performance. From this point of view, the development of a RFeB-type magnet (rare-earth magnet), made from a rare-earth element (R), Boron (B) and Iron (Fe), has up until now been popular.

However, to further increase the demand for rare-earth magnet, a stable exhibition of the excellent magnetic characteristics becomes important in order to secure the reliability of the product made from the magnet. Because the main reason that rare-earth magnet degrade its magnetic characteristics lies on an oxidization of the main components such as Fe and R, rare-earth magnet is demanded to possess excellent corrosion resistance against the oxidization. Especially, in the case of rare-earth magnet that gets exposed to high-temperature condition where the oxidization can easily proceed, the magnet is demanded to possess excellent corrosion resistance under high-temperature condition. For example, in the case of use for each kinds of motors equipped in engine rooms of automobile cars, or in the case of use for driving motors in hybrid cars or electric cars, the rare-earth magnet has to maintain high magnetic characteristics at high-temperature range exceeding 100° C.

However, a NdFeB-type magnet, for example, is poor in heat resistance with its generally large temperature-dependency (temperature coefficient), resulting in considerable decrease in coercivity at high-temperature range. So far, to improve the temperature dependency itself has been difficult. Therefore, up to this date, it has been dealt by initially enlarging coercivity (iHC) of rare-earth magnet, taking into account the degree of degradation in magnetic characteristics.

By the way, many of applications concerned with rare-earth magnets with enhanced initial magnetic characteristics have been made, for example, the following open patents can be listed.
\mathring{1}U.S. Pat. No. 4,802,931, U.S. Pat. No. 4,851,058

In the former open patent, an alloy is disclosed which are composed of less than 40 atomic % (at %) R or R′ that are rare-earth elements, 0.5-10% at % B and a remainder of Fe, and whose main phase is (R, R′)₂(Fe, TM)₁₄B₁ (TM: transition element). Indeed, what is disclosed as a magnetic powder composed of the alloy is only an isotropic magnetic powder produced by quenching solidification. Moreover, concerning with time-variation properties or its controlling method of the isotropic magnetic powder or the applied hard magnets, nothing has been disclosed in this open patent.

In the latter open patent, although similar alloys where the above-mentioned R is neodymium (Nd) or praseodymium (Pr) have, in this case again, nothing is disclosed about the above-mentioned time-variation properties.
\mathring{2} U.S. Pat. No. 4,402,770

In this open patent, alloys composed of (M_{w}XₓB₁₋ₓ)_{1-y}(R_{z}La_{1-z})_{y} have been disclosed. M represent Fe or Co and so on, and X represents Si or Al and so on. By making the alloy into amorphous through quenching solidification method and then crystallizing it through heat processing, an isotropic magnetic powder can be obtained. Here La must be an essential component for formation of the above-mentioned amorphous structure.

Again, in this open patent, nothing is reported about --- or its controlling method of the isotropic magnetic powder. \mathring{3} Japanese examined Patent Publication No. 6-82575 (Japanese Patent No. 1947332), Japanese examined Patent Publication No. 7-68561 (Japanese Patent No. 2041426), Japanese Patent No. 2576671 and Japanese Patent No.

Alternative production methods, other than the above-mentioned quenching solidification method (melt spinning method), include the HDDR (hydrogenation-disproportionation-desorption-recombination) processing method and the d-HDDR processing method.

The HDDR processing method is used to produce RFeB-type isotropic magnet powder and RFeB-type anisotropic magnet powder, and it generally has two production steps. That is to say, the first step of 3-phase decomposition (disproportionation) reaction (the hydrogenation step) is carried out while maintained at 773-1273 K in a hydrogen gas environment on the order of 100 kPa (1 atm), and after that is the dehydrogenation step (the second step) where dehydrogenation occurs under vacuum.

On the other hand, d-HDDR is used predominantly in as a production method for RFeB-type anisotropic magnet powder. As reported in detail in commonly-known literature (Mishima, et. al.: Journal of the Japan Applied Magnetics Society, 24 (2000), p. 407), it is defined as the control of the reaction rate between the RFeB-type alloy and hydrogen when going from room temperature to a high temperature. In detail, the four principal production steps are the low-temperature hydrogenation step (step 1) where hydrogen is sufficiently absorbed into the RFeB-type alloy at room temperature, the high-temperature hydrogenation step (step 2) where the 3-phase decomposition (disproportionation) reaction occurs under low hydrogen pressure, the evacuation step (step 3) where hydrogen is decomposed under as high a hydrogen pressure as possible, and the desorption step (step 4) where the hydrogen is removed from the material. The point, which differs from the HDDR process is that through the preparation of multiple production steps with different temperatures and hydrogen pressures, the rection rate of the RFeB-type alloy and hydrogen can be maintained relatively slow, thus homogeneously anisotropic magne powder. In these four open patents above-mentioned, a magnetic powder produced by those processes is reported.

In Japanese Examined Patent Publication No. 6-82575 a RFeB-type isotropic magnet powder which possesses recrystallized tetragonal structure is disclosed, and in Japanese Examined Patent Publication No. 7-68561 the production method of RFeB-type isotropic magnet powder using the HDDR process is disclosed. Indeed, even in these open Patent, nothing about time-variation properties etc. of the isotropic magnet powder is disclosed.

In Japanese Patent No. 2576671 as well as Japanese Patent No. 2586198, RFeB-type anisotropic magnet powder with superior corrosion resistance as well as bonded magnet are disclosed. The prior magnet powder produced through thermo-plastic process is poor in corrosion resistance due to an introduction of a plastic process strain. On the other hand, as those open patents report, an corrosion resistance of magnet powder produced using the HDDR process improves with no introduction of a plastic process strain. That is, in the case of magnet powder produced using the HDDR process, the corrosion resistance improves because there is no grain boundary in its recrystallized structure, nor is stress strain caused by plastic process. However, the disclosed method in this open patent was far from sufficient in terms of improvement in corrosion resistance or magnetic characteristics of the magnet powder.
\mathring{4} Japanese Unexamined Patent Publication No. 2002-93610

In this open patent, a method to diffuse (or coating) Nd or Dy on the surface or inside of anisotropic magnet powder by means of diffusion heat process, is disclosed. The heat processed Nd or Dy acts as an oxygen getter, control as well as prevent a direct oxidization of R or Fe that compose main phase of magnet powder. As a result, the diffusion heat processed magnet powder achieves an excellent corrosion resistance. However, the corrosion resistance was not surely a sufficient level.

As mentioned above, even if the prior rare-earth magnet powder and the magnet have a superior initial magnetic characteristics, the corrosion resistance was insufficient. In addition, even ones with improved corrosion resistance were not surely sufficient level, with no coexistence of magnetic characteristics and corrosion resistance on a high level. However, to achieve a coexistence of high functionalization and high reliability of the product using rare-earth magnet, to improve corrosion resistance of RFeB-type magnet powder with superior magnetic characteristics and the applied rare-earth magnets is very important.

In addition, although many of the above-mentioned open patents are illustrating La as R that compose a main phase of RFeB-type magnet powder, none of them reports an example in which La is R. Also none of them utilizes La as to improve corrosion resistance of magnet powder.

### DISCLOSURE OF THE INVENTION

The present invention was developed in order to solve problems as those mentioned above. That is to say, the purpose is to offer a bonded magnet with superior magnetic characteristics and small time-dependent deterioration, as well as RFeB-type magnet alloy and RFeB-type magnet powder which make such bonded magnet, and their production methods.

As a result of many types of systematic experiments and diligent research to solve these challenges, the present inventors found out that, by means of introducing proper amount of La into bonded magnet and then diffusing or coating, an excellent bonded magnet with superior time-variation properties such as corrosion resistance and with little decline in magnetic characteristics was achievable, and accomplished inventions as follows.

(Bonded Magnet Alloy)

First, the component of the bonded magnet alloy of the present invention (hereafter simply referred to as magnet alloy) are at least Fe as a main component, 11-15 at % R that includes yttrium (Y) and does not include lanthanum (La), 5.5-10.8 at % B and 0.01-1.0 at % La, and has superior corrosion resistance.

La is a kind of R that composes RFeB-type magnet or RFeB-type magnet powder because La is also an rare-earth element. However, the RFeB-type magnet containing La as R is inferior in the magnetic characteristics to the RFeB-type magnet containing neodymium (Nd), praseodymium (Pr), dysprosium (Dy) or terbium (Th) as R. For this reason, La is indeed rarely chosen as R. Furthermore, the actual condition is that in the RFeB-type magnet of which the magnetic characteristics is intended to be improved as good as possible, containing of La has been intended to be avoided.

However, on the contrary to such customary understanding, the present inventor paid attention to the La, and succeeded to improve the corrosion resistance (specifically, deterioration resistance against oxidization or oxidization resistance) of RFeB-type magnet powder, scarcely deteriorating the magnetic characteristics. The reasons for this are considered as follows.

La has the largest oxidation potential of all rare-earth elements. Because of this, in the case of the RFeB-type alloy containing La, La is used as a so-called oxygen getter and is selectively (at a priority) oxidized as compared with the above-mentioned R (Nd, Dy, etc.). Consequently, a magnet powder containing La exhibits higher corrosion resistance with superior time-variation properties because the oxidization of the main phase RFeB-type crystal is markedly suppressed.

As mentioned above, Dy, Th, Nd, Pr, etc. can be used in place of La. However, compared with these elements, use of La brings about more sufficient oxidization suppression effect of magnet powder or bonded magnet, and with respect to cost, to use La is cheaper over these other elements.

Here, to harmonize corrosion resistance and magnetic characteristics on high level, a composition of La becomes important. An avoidable impurity level of La is approximately 0.001 at %. When La is added on a very small quantity exceeding the avoidable impurity level, corrosion resistance of bonded magnet improves. And, in terms of achieving a sufficient improvement of corrosion resistance, La was added with the lower limit content of 0.01 at %. On the other hand, more than 1.0 at % content yields the unfavorable result of lowering the iHc. Thus, in terms of improvement of corrosion resistance and suppression of decline in iHc, 0.01-0.1 at % of La content is more favorable.

As stated above, a magnet powder and a hard magnet (bonded magnet) obtained from the raw material of a magnet alloy containing proper amount of La shows an superior time variation characteristics, scarcely deteriorating the superior magnetic characteristics. In addition, the cost for this is lower compared to the use of Nd or Dy.

Because a bonded magnet produced from the raw material of this magnet alloy exhibits superior corrosion resistance, the use not only for equipment used under room temperature environment, but also the use for equipment used under high temperature environment where deterioration due to oxidization easily occur (for example, driving motors for hybrid cars or electric cars) is favorable.

By the way, the magnet alloy of the present invention can be an ingot melt and then cast by various melting method (high-frequency melting method, nuclear melting method), or a coarse powder achieved via hydrogen crushing or mechanical crushing. Furthermore, it can be a magnet powder itself of the undermentioned isotropic magnet powder or anisotropic magnet powder. Consequently, the magnet powder of the present invention does not regard the forms such as shape or grain diameter. Additionally, it is sufficient if the alloy of the present invention is one used for production of bonded magnet or magnetic powder with superior corrosion resistance, and does not regard their production process. For example, it can be what is supplied as the raw material for the undermentioned hydrogenation processing method (HDDR processing or d-HDDR processing).

Moreover, the alloy of the present invention is not limited to a single type of magnet alloy which has the above-mentioned composition. That is to say, it is also favorable, mixing the plural kinds of alloys, and if the mixture as the whole forms an alloy which has at least the above-mentioned composition. For example, the case of a mixed alloy in which a RFeB-type alloy containg 11-15 at % R and 5.5-10.8 at % B, and a La-type material (for example, a simple substance of La, a La alloy such as LaCo or its hydride) are mixed together, is also defined as a bonded magnet in the present invention. And these mixed alloys also become the raw material to which HDDR processing or d-HDDR processing are applied.

The composition of magnet alloy in the present invention is what is described above, and the reason why R and B were restricted as above-mentioned is as follows.

With less than 11 at % of R, the primary crystal of α-Fe becomes liable to precipitation causing a decrease in iHc, with more than 15 at % of R, R₂Fe₁₄B phase decreases, decreasing the maximum energy product (BH) max, thus neither of them is unfavorable. Here this R is more than one kind of scandium (Sc), yttrium (Y) and lanthanide (La). To get superior magnetic properties, it is ideal to usee more than one of Y, cerium (Ce), Pr, Nd, samarium (Sm), gadolinium (Gd), Th, Dy, holmium (Ho), erbium (Er), thulium (Tm) as well as lutetium (Lu) for R. Out of these, it is especially desirable to use at least one of Pr, Nd or Dy for R in terms of cost as well as magnetic properties.

With less than 5.5 at % of B, a soft magnetic R₂Fe₁₇ phase precipitates, causing a decrease of magnetic properties, with more than 10.8 at %, R₂Fe₁₇B phase decreases, also decreasing magnetic properties, thus neither of them is favorable.

Additionally, in the magnet alloy of the present invention, it is favorable to include at least one of gallium (Ga) or aluminum (Al) (hereafter referred as to Group 1 Elements) with a total amount of 0.05-1.0 at %. These elements improve the coercivity iHc of the magnet.

In the magnet alloy of the present invention, it is favorable to include niobium (Nb) (hereafter referred as to 2 Element) with a amount of 0.05-1.0 at %. This element improve the residual remanence (Br) of the magnet.

The maximum energy product (BH)max can be improved with the addition of both elements from the Group 1 Elements and 2 Element. In any case if the total is less than 0.05 at % there is no actual effest and if more than 1.0 at % the iHc, Br or (BH)max will decrease bringing on an unfavorable result.

If you think of cost and magnetic properties, it is desirable to have a content of 0.05-1.0 at % or better yet 0.2-0.4 at % (on the order of 0.3 at %) Ga and 0.05-0.8 at %, or better yet 0.1-0.4 at % (on the order of 0.2 at %) Nb. In particular, it is more desirable to have both of a content of 0.05-1 at % Ga and a content of 0.05-0.8 at % Nb, improving both of iHc and Br.

Furthermore, in addition to the above-mentioned elements, it is desirable to have a content of 0.1-10 at %, or better yet 1-10 at % of cobalt (Co). This is because Co is an element that will increase the Curie temperature, as well as increasing the heat durability. With less than 0.1 at % of Co content, there is not an actual effect. On the other hand, because Co is expensive, less than 10 at % of the content is desirable in terms of industrial cost. Upon addition of La, if an alloy or a compound of La and Co is used as the row material, both of them can be contained in the magnet powder for low cost.

Needless to say, unavoidable impurities may exist to a certain extent in the magnet alloy of the present invention and the over all composition accounts for the difference in the Fe balance. In addition, each indicated composition in the present detailed statement is given when defining the whole alloy or magnet powder as 100 at %.

What is mentioned above concerning a composition or shapes falls under the undermentioned magnet powder of the present invention, its production method, as well as bonded magnet.

(Magnet Powder and its Production Method)

(1) An example of shapes or used forms of the above-mentioned alloy is a magnet powder. For example, an isotropic magnetic powder given by employing the HDDR process to an ingot etc. composed of the above-mentioned magnet alloy, or the d-HDDR processed anisotropic magnet powder.

That is to say, an isotropic magnet powder obtained by the HDDR process which includes putting an ingot, with alloy composition of at least the main component Fe, R including Y without La of 11-15 at %, B of 5.5-10.8 at % and La of 0.01-1.0 at %, through the hydrogenation step while maintaining the ingot between 1023-1173 K in a hydrogen atmosphere, and then after the hydrogenation step, carrying out the desorption step where hydrogen is removed, is used for bonded magnet with superior corrosion resistance.

On the other hand, anisotropic magnet powder obtained by the d-HDDR process which includes putting an ingot, with alloy composition of at least the main component Fe, R including Y without La of 11-15 at %, B of 5.5-10.8 at %, and La of 0.01-1.0 at %, through the low temperature hydrogenation step while maintaining the ingot at less than 873 K in a hydrogen atmosphere, and then after the low-temperature hydrogenation step, carrying out the high-temperature hydrogenation step while maintaining 20-100 kPa and 1023-1173 K in a hydrogen atmosphere, and then the high-temperature hydrogenation step, carrying out the first evacuation step while maintaining 0.1-20 kPa and 1023-1173 K in a hydrogen atmosphere, and after the first evacuation step, carrying out the second evacuation step where the hydrogen is removed, is used for bonded magnet with superior corrosion resistance.

(2) Additionally, not limited to these, magnet powder obtained by the following production method of the present invention is also a magnet powder involved in the present invention.

The production method of isotropic magnet powder of the present invention is a production which includes the HDDR process which includes putting a magnet alloy, with alloy composition of at least the main component Fe, R including Y without La as well as B, through the hydrogenation step while maintaining the alloy between 1023-1173 K in a hydrogen atmosphere, and then after the hydrogenation step, carrying out the desorption step where hydrogen is removed, to which diffusion heat process is annexed or unified where a La blended powder that can be obtained by blending the obtained RFeB-type powder after the hydrogenation process or the dehydrogenation process with La-type powder composed of more than one kind that includes a simple substance of La, a La alloy, a La compound and their hydride (a simple substance of La, a La alloy as well as a hydride of La compound, hereafter referred as to La hydride), is heated at 673-1123 K and La is diffused on the surface and the inside of the RFeB-type powder.

In addition, thus achieved isotropic magnet powder, when regarding the whole as 100 at %, includes at least 11-15 at % of the above-mentioned R, 5.5-10.8 at % of the above-mentioned B as well as 0.01-1 at % of the above-mentioned La, and is used for bonded magnet with superior corrosion resistance.

The production method of anisotropic magnet powder of the present invention is a production which includes the d-HDDR process which includes putting a magnet alloy, with alloy composition of at least the main component Fe, R including Y without La as well as B, through the low temperature hydrogenation step while maintaining the ingot at less than 873 K in a hydrogen atmosphere, and then after the low-temperature hydrogenation step, carrying out the high-temperature hydrogenation step while maintaining 20-100 kPa and 1023-1173 K in a hydrogen atmosphere, and then the high-temperature hydrogenation step, carrying out the first evacuation step while maintaining 0.1-20 kPa and 1023-1173 K in a hydrogen atmosphere, and after the first evacuation step, carrying out the second evacuation step where the hydrogen is removed, to which diffusion heat process is annexed or unified where a La blended powder that can be obtained by blending the obtained RFeB-type powder after the high-temperature, the first evacuation process or the second evacuation process with La-type powder composed of more than one kind that includes a simple substance of La, a La alloy, a La compound and a La hydride, is heated at 673-1123 K and La is diffused on the surface and the inside of the RFeB-type powder.

In addition, thus achieved anisotropic magnet powder, when regarding the whole as 100 at %, includes at least 11-15 at % of the above-mentioned R, 5.5-10.8 at % of the above-mentioned B as well as 0.01-1 at % of the above-mentioned La, and is used for bonded magnet with superior corrosion resistance.

In these magnet powder, the addition form of La is modified from the previously explained magnet powder. That is to say, the previously stated magnet powder is produced form use of the raw material that includes La. On the other hand, to the latter explained magnet powder, La is added on the way of its production, or La is added after production of the RFeB-type powder.

It goes without saying that, no matter which way is used, as long as La exists, corrosion resistance of magnet powder or bonded magnet improves and thus there are no problems within the scope of the present invention regarding the form that La addition takes.

It must be also said, for even more effective control of the oxidation of magnet powder which has La, which has an oxygen-getter function, that is even more favorable if the La exists on the surface of, or in the vicinity of, the magnet powder structural grains. Consequently, rather than having La included initially in the magnet alloy, it is more advantageous to have La diffuse into, or onto the surface of the magnet powder by mixing La-type material with the RFeB-type powder during or after the production of the powder, for an achievement of magnet powder with superior corrosion resistance.

In a case La is added after the production of magnet powder, the diffusion heat process is conducted after the desorption process in the above-mentioned HDDR process or after the second evacuation process in the above-mentioned d-HDDR process. In a case La is added during the production of magnet powder, the diffusion heat process is conducted after the hydrogenation process in the above-mentioned HDDR process or after the high-temperature hydrogenation process or the second evacuation process in the above-mentioned d-HDDR process. Here, though each process of the HDDR process and d-HDDR process as well as the diffusion heat process can be conducted individually, it is more efficient if the both are conducted in the unified manner. For example, a case in which the diffusion heat process and the second evacuation process are conducted simultaneously after the D-HDDR process.

The case in which each process is conducted individually corresponds to what is expressed as [annexation] in the present invention, and the case in which each process is conducted in the unified manner corresponds to what is expressed as [unification] in the present invention.

In addition, in a case La is added during the production of magnet powder, the partner material the RFeB-type powder exists, more or less, as a hydride state (hereafter referred as to the RFeBHx powder). Because La is added after the hydrogenation process and before the hydrogenation process, or after the high-temperature hydrogenation process and before the second evacuation process.

In this RFeBHx powder etc., R or Fe are in a state where they can hardly be oxidized compared to the case where hydrogen is not included. For this reason, diffusion or coating of La can be conducted in a state of controlled oxidation, and magnet powder with superior corrosion resistance can be produced at stable quality. Also for the same reason, it is favorable if the La-type powder is on a hydride state. For example, LaCoHx etc. is favorable.

Additionally, to achieve a magnet powder with superior both magnetic characteristics and corrosion resistance, it is favorable if the RFeB-type powder is a recrystallized polycrystal (RFeBHx) due to that hydrogen is removed from the three-phase decomposed RH₂ phase after (high-temperature) hydrogenation process and then crystal direction of Fe₂B phase is transcribed. This polycrystal can be obtained, for example, after the first evacuation step in the d-HDDR process. Consequently, it is favorable if the production method of anisotropic magnet powder of the present invention is the one where the above-mentioned diffusion heat process step is conducted after the above-mentioned first evacuation step. Moreover, it is efficient if the above-mentioned diffusion heat process step and the above-mentioned second evacuation step are unified and conducted in the unified manner.

By the way, the diffusion heat process step is the step where surface diffusion (coating) or center diffusion of La into the surface or center of each structural grain of the RFeB-type powder or the RFeBHx powder occurs. This diffusion heat process step can be carried out after mixing with La-type material, or simultaneously with that mixing. If the processing temperature is less than 673 K, sufficient diffusion process becomes difficult, as it is difficult for the La-type material to become a liquid phase. On the other hand, if above 1123 K, with the crystal grain growth of the RFeB-type magnet powder, etc., sufficient improvement of the corrosion resistance (decrease of the permanent demagnetizaiton ratio) cannot be achieved with the decrease in iHc. A duration of 0.5-5 hours for this processing time is ideal. If less than 0.5 hours, the La diffusion will be in sufficient, and the corrosion resistance of the magnet powder will not be much improved. On the other hand, if greater than 5 hours, a decrease in iHc will be induced. As we all know, it is preferable that this diffusion heat process step be carried out in an atmosphere where oxidation is prevented (such as in a vacuum atmosphere). In addition, in a case this diffusion heat process step is conducted in the unified manner with the dehydrogenation process in the HDDR process, or with the first evacuation process or the second evacuation process in the d-HDDR process, their processing temperature and processing time as well as processing atmosphere are adjusted to the common range to both.

Although there is no specific requirement for the forms such as grain size of the above-mentioned RFeB-type powder or the La-type powder, from the viewpoint of conducting the diffusion heat process step efficiently, not more than 1 mm average particle size of the RFeB-type powder and not more than 25 μm average grain size of the La-type powder is favorable.

The RFeB-type powder can be, according to degree of the step progress, a hydride, magnet powder, or the one whose structure has been three phase decomposed as well as their recrystal.

The La-type powder is composed of more than one kinds that include a simple substance, a La alloy, a compound of La or a hydride of La, in consideration of effects etc. on magnetic properties, it becomes more favorable if it is composed of an alloy between transition metallic element (TM) and La, a compound (including metallic compound) or a hydride. For, example, LaCO (Hx), LaNdCo (Hx), LaDyCo (Hx) and so on. Additionally, in the case the La-type powder is composed of an alloy or a compound (including hydride), it is more favorable if the amount of the La contained in the alloy etc. is not less than 20 at %, not less desirably 70 at %.

(Bonded Magnet)

By using these magnet, bonded magnet with superior magnetic characteristics and corrosion resistance can be achieved.

For, example, in the case using isotropic magnet powder, the bonded magnet of the present invention is characterized by that it can be achieved by mixing binder with the obtained isotropic magnet powder through the HDDR process that is composed of at least the main component Fe, 11-15 at % of R including Y without La, 5.5-10.8 at % of B as well as 0.01-1.0 at % of La, and then by compression molding, as well as by its superior corrosion resistance.

Or, in the case using anisotropic magnet powder, the bonded magnet of the present invention is characterized by that it can be achieved by mixing binder with the obtained anisotropic magnet powder through the d-HDDR process that is composed of at least the main component Fe, 11-15 at % of R including Y without La, 5.5-10.8 at % of B as well as 0.01-1.0 at % of La, and then by compression molding, as well as by its superior corrosion resistance.

Additionally, the presented isotropic magnet powder and anisotropic magnet powder are not limited to ones produced by the above-mentioned production method.

The Best Conditions for Implementation of the Present Invention

A. Condition for implementation All of the following conditions for implementation are described detail in the present invention

(1)HDDR Processing Method

The HDDR process related to the present invention includes carrying out the hydrogenation step and desorption step on an alloy with the above-mentioned composition. The conditions for the hydrogenation step are as stated above.

In detail. The desorption step is, for example, carried out in an atmosphere with hydrogen pressure less than 10⁻¹ Pa. And it is good if the temperature during the desorption step is, for example, 1023-1173 K. The hydrogen pressure in this document is, unless specified, the hydrogen partial pressure. Accordingly, as long as during the various steps the hydrogen partial pressure is within the specified values, it is acceptavle to have a mixture with inert gasses.

The above-mentioned processing times for the various steps are besed on the processing amount of a single batch. For example, if the processing amount for a single batch were 10 kg, it is best to carry out the hydrogenation step on the order of 360-1800 minutes, and the desorption step o the order of 30-180 minutes. Other than that, the HDDR process itself is on in detail in the above-mentioned Japanese Examined Patent Publication No. 7-68561 and it would be best to consult that as appropriate.

The magnet powder obtained by this HDDR processing method has industrial significance as isotropic magnet powder. This magnet powder has, for example, the superior magnetic characteristics of iHc of 0.8-1.7 (MA/m) and (BH)max of 60-120 (kJ/m³).

(2)d-HDDR Processing Method

The d-HDDR process related to the present invention includes carrying out the low-temperature hydrogenation step, high-temperature hydrogenation step, first evacuation step and second evacuation step on an alloy with the above-mentioned composition. Specifically, the first step or the low-temperature hydrogenation step is a step where hydrogen is sufficiently occluded into alloy (the RFeB-type alloy). The second step or the high-temperature hydrogenation step is a step where hydrogen and alloy (the RFeB-type alloy) react slowly. At this time, the crystals of the Fe₂B phase, which is the anisotropy direction transcription phase, precipitate predominantly uni-axially. In the third step, or the first evacuation step, while the Fe₂B crystal direction remains the same, RFeB crystals precipitates. The forth step, or the second evacuation step is a step where the remaining hydrogen in the RFeB-type alloy is removed.

The low-temperature hydrogenation step is, for example, carried out in an atmosphere with hydrogen pressure of 30-200 kPa. The second evacuation step is, for example, carried out in an atmosphere with hydrogen pressure not more than 10⁻¹ Pa, and with a temperature, for example, on the order of 1023-1173 K. In case of unifying the second evacuation step and the diffusion heat process step, considering the upper limit temperature of the diffusion heat process step, processing temperature of 1023-1123 K is favorable. Here The desorption process is composed by a combination of the first evacuation step and the second evacuation step.

The above-mentioned processing times for the various are based on the processing amount of a single batch. For example, if the processing amount of a single batch were 10 kg, it is best to carry out the low-temperature hydrogenation step for not shorter than 30 minutes, the high-temperature hydrogenation step on the order of 360-1800 minutes, the first evacuation step on the order of 10-240 minutes and the second evacuation step on the order of 10-120 minutes. Other than that, the d-HDDR process itself is reported in the above-mentioned Japanese Unexamined Patent Publication No. 2001-76917 and it would be best to consul that as appropriate.

The magnet powder obtained via this d-FDDR processing method is an anisotropic magnet powder showing superb magnetic characteristics. These characteristics are, for example, iHc of 0.8-1.7 (MA/m) and (BH)max of 190-290 (kJ/m³).

For an alloy for the HDDR process and the d-HDDR process, a coarsely crushed ingot in a dry or wet mechanical crusher (jaw crusher, disc mill, ball mill, vibrating mill, jet mill, etc.) can be also used.

(3)Bonded Magnet and its Production Method

This bonded magnet is obtained by carrying out a mixing step, where the above-mentioned isotropic magnet powder or anisotropic magnet powder is mixed with a binder, and a formation step, where the mixed powder obtained from the mixing step is formed. The binder can be a binder like the above-mentioned organic binder or a metal binder, or others. Resin-type organic binders are the most common. The resins used in resin binders can be a thermo-setting resin or a thermo-plastic resin. If this type of binder is used, in addition to the above-mentioned mixing step, it is good to carry out a kneading step where the magnet powder and resin binder are kneaded. The above-mentioned molding step can be compression molding, injection molding, extruction molding, etc. In the case that anisotropic magnet powder is used for the magnet powder, the anisotropic magnet powder should be formed in a magnetic field. Furthermore, in the case of using heat-hardening resin as the resin binder, a hardening (curing) step should be carried out during or after the formation step.

### B. EXAMPLES

The following examples are offered so as to explain the present invention in detail.

### Examples 1

### Sample No. 1-5

(1)Production of Anisotropic Magnet Powder

\mathring{1} By weighing raw material alloys or raw material elements and then melt-casting via high-frequency melt furnace, 100 kg of the raw material alloy ingot (an ingot fot bonded magnet) for anisotropic magnet powder was produced. The composition of the ingot was Nd: 12.5%, b: 6.4%, Ga: 0.3%, Nb: 0.2%, the remainder: Fe (unit: at %, and so forth).

To this alloy ingot, heat processing of 1423 K (1140 C) ×40 hours was applied in an argon atmosphere, and the structure of alloy ingot was homogenized. Additionally, this homogenizing heat treated alloy ingot was coarsely crushed into not more than 10 mm on its average particle size, using jaw crusher.

\mathring{2} To thus obtained 10 kg of the RFeB-type alloy (coarsely crushed powder), first, the low-temperature hydrogenation step, the high-temperature hydrogenation step and the first evacuation step in the d-HDDR process was applied. That is to say, each sample ingot was subject to sufficient hydrogen absorption (low-temperature hydrogenation step) under a hydrogen atmosphere at a hydrogen pressure of 100 kPa at room temperature. Next, heat treatment (high-temperature hydrogenation step) was carried out for 8 hours at 1113 K and a hydrogen pressure of 35 kPa under a hydrogen atmosphere. Following that, heat treatment (first evacuation step) was carried out for 150 minutes at 1113 K and 0.1-20 kPa hydrogen pressure under a hydrogen atmosphere.

\mathring{3} By mixing the obtained RFeB-type alloy after the first evacuation step (RFeBHx-type powder) with each of three kinds of the La-type powder shown FIG. 1 to prepare the La-type mixed powder (mixing step), then heated at 1073 K for 3 hours (diffusion heat treatment step). At that time, a vacuum atmosphere of not more than 10⁻¹ Pa was created by use of rotary pump or diffusion pomp (second evacuation step). In the present example, these mixing step, the diffusion heat treatment step and the second evacuation step were conducted in the unified manner. Thereafter it was cooled and an anisotropic magnet powder with not more than 212 μm of the average grain size was obtained (Sample No. 1-5). The terminal composition of the obtained anisotropic magnet powder are also shown in table 1.

The La-type powders shown in FIG. 1 were produced as follows. First, according to the desired composition, the raw material was weighed and 3 kg of melt-cast ingot was prepared. This ingot was hydrogen crushed (HD) under a hydrogen atmosphere (room temperature×0.1 MPa). Consequently, by making the crushed powder finer by use of a vibration mill, the La-type powder (a hydride) was achieved with an average particle diameter of 10 μm. This is the same for the La-type powder shown in table 2 and table 4. Values displayed in [the La-type powder] column in each figure represents composition ratios of the La-type powder, for example, (La₅₀Nd₅₀)₈₀Co₂₀ represents that it is composed of 80% (La₅₀Nd₅₀)₈₀Co and of 20% single substance of Co (the unit is at %).

\mathring{4} As comparison example, next, three kinds of anisotropic magnet powder were prepared. That is, as compared with the above-mentioned examples, the one with 3 at % of La additive (Sample No. C1), the one heat treated at 1173 K in the diffusion heat treatment step (Sample No. C2) and the one with no addition of La (Sample No. C3). The used La-type powders were displayed together in table 1.

(2)Production Method of Bonded Magnet

Using the above-mentioned various kinds of anisotropic magnet powder, the following bonded magnets were produced.

First, each magnet powder is mixed with epoxy resin (3 wt %) dissolved beforehand in butane. Then bonded-magnet-use pellets are produced by volatilizing the butane under vacuum. This pellets were aligned under a 2.5 T magnetic field, and made into bonded magnets with a shape 7 mm cubed by heat-compression molding. This heat-compression molding was carried out under a condition of 150° C.×9 ton.

(3) Magnetic Measurement of the Magnet Powder and Bonded Magnet

\mathring{1} Magnetic measurement was carried out for the various obtained magnet powders. For the measurement of iHc, an ordinary BH tracer could not be used, so the iHc was measured in the following way. First, the magnet powder is classified into grain diameter between 75-106 μm. Using this classified magnet powder, (BH)max and iHc are measured after forming so as to achieve a demagnetization coefficient of 0.2 and after magnetization at 4.57 MAm⁻¹ after alignment in a magnetic field. These results are brought together and shown in Table 1.

\mathring{2} Additionally, the maximum energy products (BH)max, the remanent magnetic flux density Br and intrinsic coercivity iHc were measured with a BH tracer. The “-” in Table 1 indicates when the values were extremely undesirable which is no worth investigating. These results are brought together and shown in Table 1.

\mathring{3} Furthermore, the permanent demagnetization ratio was measured for each bonded magnet. The permanent demagnetization ratio is the ratio of a bonded magnet's initial magnetic flux and the difference between the initial magnetic flux and the magnetic flux after remagnetization after being held for 1000 hours in an air atmosphere at 353 K (80° C.), 373 K (100° C.) or 392 K (120° C.) (an so forth in following examples). Here the magnetization is carried out at 1.1 MA/m (45 kOe). A fluxmeter was used to measure the magnetic flux. The permanent demagnetization ratios gathered in this manner are brought together in Table 1.

(4)Evaluation

\mathring{1} The following can be noticed from Table 1.

First of all, bonded magnets of Examples to which a proper amount of La is added, in any cases, in comparison with bonded magnets of Comparison Examples, exhibits smaller values of the permanent demagnetization ratio. Above all, in the case that the La-type powder includes not only La, but also Nd or Dy such as bonded magnets of Sample No. 3 or Sample No. 4, due to a multiplier effect of the both, even small value of the permanent demagnetization ratio was revealed.

In addition, in any bonded magnets of Sample No. 1-5, in spite of an addition of La, (BH)max exhibited excellent values about 157 kJ/m3. This was on the same level as bonded magnet of Sample No. 3 where no La is added.

Indeed, when the amount of La exceeds 1 at % such as bonded magnet of Sample No. C1, not only the magnetic characteristics but also the permanent demagnetization ratio deteriorates. If the processing temperature of the diffusion heat process step exceeds 1123 K such as Sample No. C2, both of the magnetic characteristics and the permanent demagnetization ratio considerably deteriorates. This can be considered that because crystal grain growth of a main phase R2Fe14B occurs, causing a decrease of iHc.

### Example 2

### Sample No. 6

An alloy ingot composed of Nd: 12%, B: 9.0%, Ga: 0.4%, Nb: 0.1% and the remainder: Fe was produced in the same manner as Example 1, and the homogenizing heat treatment of 1393 K×20 hours was applied. Hereafter, in the same manner as Example, the homogenizing heat treated alloy ingot was coarsely crushed, applying the d-HDDR process and the diffusion heat process step, an anisotropic magnet powder (Sample No. 6) and a bonded magnet were produced. Here an amount of the La diffusion is 0.2 at %. The used La-type powder, the terminal composition of the obtained anisotropic magnet powder and its magnetic characteristics, as well as the magnetic characteristics and the permanent demagnetization ratio of the obtained bonded magnet were brought together and shown in Table 2.

As Comparison Example, a bonded magnet produced from anisotropic magnet powder with no La additive (Sample No. C4) was prepared.

As comparing the both bonded magnet, although the magnetic properties were on the same level due to a small amount of La, bonded magnet of Sample No. 6 as compares with bonded magnet of Sample No. C4, exhibits considerably deteriorated permanent demagnetization ratio. In particular, observing the permanent demagnetization ratio after maintaining at high-temperature range not lower than 373 K, it can be seen that the degree is large.

### Example 3

### Sample No. 7

An alloy ingot composed of Nd: 12.5%, B: 6.4%, Ga: 0.3%, Nb: 0.2%, La: 0.4% and the remainder: Fe was produced in the same manner as Example 1, and by employing the same-conditioned as Example 1 homogenizing heat treatment and the d-HDDR process, an anisotropic magnet powder (Sample No. 7) was produced. Unlikely the case of Example 1, mixing of La-type powder or diffusion heat treatment were not performed.

Using these obtained anisotropic magnet powder, a bonded magnet was produced in the same manner as Example 1.

Also, as Comparison Example, an alloy ingot composed of Nd: 12.5%, B: 6.4%, Ga: 0.3%, Nb: 0.2%, the remainder: Fe and with no La, was produced in the same manner as Example 1, and by employing the same-conditioned as Example 1 homogenizing heat treatment and the d-HDDR process, an anisotropic magnet powder (Sample No. 7) was produced. Needless to say, the diffusion heat treatment etc. was not performed, either.

Using these obtained anisotropic magnet powder (Sample No. C5), a bonded magnet was produced in the same manner as Example 1.

The terminal composition and magnetic characteristics of anisotropic magnet powder related to Sample No. 7 and Sample No. C5, as well as magnetic characteristics and permanent demagnetization ratio of the associated bonded magnet powder were brought together and shown in Table 3.

As comparing the both, although the magnetic properties merely deteriorate due to a content of La, the permanent demagnetization ratio considerably deteriorates. In particular, it can be seen that the permanent demagnetization ratio after maintaining at equal of or higher temperature than 373 K deteriorates considerably.

By the way, as clearly seen from comparison between bonded magnet of Sample. No. 1 and bonded magnet of Sample No. 7, despite the almost the same composition, it can be seen that magnetic characteristics and the permanent demagnetization ratio are more superior in bonded magnet powder of Sample No. 1.

That is to say, rather than having La included initially in the magnet alloy, it is more favorable to have La diffuse into, or onto the surface of the magnet powder by the later diffusion heat treatment step.

### Example 4

### Sample No. 8

Using the same alloy ingot as Example 1, after employing the same homogenizing heat treatment and the coarse crushing, the HDDR process was applied in stead of the d-HDDR process. That is to say, under a hydrogen atmosphere at 1093 K and with hydrogen pressure of 100 kPa, the heat process was performed (the hydrogenation step). Following to this, maintained under a vacuum atmosphere of not more than 10⁻¹ kPa created by use of rotary pump or diffusion pomp at the same temperature (1093 K) for 60 minutes (the desorption step). Thus an isotropic magnet powder with not more than 100 μm of average grain size was produced.

With this obtained magnet powder, the La-type powder etc. displayed in Table 4 was mixed and the diffusion heat process was carried out (diffusion heat process step). This heat process condition was the same as the case of Example 1. Thus, an isotropic magnet powder related to the present Example was obtained (Sample No. 8).

As Comparison Example, an isotropic magnet powder as obtained via the HDDR process without mixing with the above-mentioned La-type powder (Sample No. C6), was prepared. Also, as a reference example, an isotropic magnet powder produced by the rapid quenching method, using the above-mentioned alloy ingot (Reference Sample), was prepared.

Using each of the obtained isotropic magnet powder, bonded magnet was produced in the same manner as Example 1. The magnetic characteristics and the permanent demagnetization ratio of each bonded magnet, together with the terminal composition and the magnetic characteristics of isotropic magnet powder are shown in Table 4.

Comparing bonded magnet of Sample No. 8 and bonded magnet of Sample No. 6, although magnetic characteristics merely decreases due to the La diffuse, the permanent demagnetization ratios considerably decreases at both temperature ranges.

As stated above, it was revealed that bonded magnet composed of magnet powder on which a proper amount of La is included or diffused, considerably decreases the permanent demagnetization ratio while scarcely deteriorating the magnetic characteristics. This tendency is true of an isotropic magnet powder and an anisotropic magnet powder.

Here it was also revealed that, rather than having La included in the raw material magnet alloy, having La diffuse into, or onto the surface of the RfeB-type powder by the later diffusion heat process step, deteriorates the permanent demagnetization ratio more considerably.

TABLE 1

Anisotrpic magnet powder

| | | Isotrpic magnet powder | | | | | | | Permanent demagnetization | | | Utilized |
|---|---|---|---|---|---|---|---|---|---|---|---|---|
| | | | Mgnetic properties | | | Mgnetic properties | | | ratio (%) | | | La-type |
| Sample | | Terminal composition | (BH)max | Br | iHc | (BH)max | Br | iHc | 353K × | 373K × | 393K × | magnet |
| No. | | (at %) | (kJm.³) | (T) | (MAm.¹) | (kJm.³) | (T) | (MAm.¹) | 1000 hr | 1000 hr | 1000 hr | powder |
| Exam- | 1 | Fe—12.3Nd—6.4B— | 302.3 | 1.33 | 0.94 | 156.8 | 0.98 | 0.93 | 5.2 | 9.7 | 15.4 | La₈₀Co₂₀Hx |
| ple | | 0.3Ga—0.2Nb— | | | | | | | | | | |
| | | 0.1Co—0.4La | | | | | | | | | | |
| | 2 | Fe—12.3Nd—6.4B— | 306.3 | 1.34 | 0.98 | 157.8 | 0.98 | 0.96 | 5.8 | 10.1 | 15.7 | La₈₀Co₂₀Hx |
| | | 0.3Ga—0.2Nb— | | | | | | | | | | |
| | | 0.05La | | | | | | | | | | |
| | 3 | Fe—12.8Nd—6.3B— | 302.3 | 1.32 | 1.02 | 156.8 | 0.98 | 1.00 | 4.6 | 8.6 | 13.4 | (La₅₀Nd₅₀)₈₀Co₂₀Hx |
| | | 0.3Ga—0.2Nb— | | | | | | | | | | |
| | | 0.1Co—0.3La—0.4Dy | | | | | | | | | | |
| | 4 | Fe—12.1Nd—6.2B— | 302.3 | 1.33 | 1.32 | 156.8 | 0.98 | 1.31 | 2.0 | 4.1 | 7.2 | (La₅₀Dy₅₀)₈₀Co₂₀Hx |
| | | 0.3Ga—0.2Nb— | | | | | | | | | | |
| | | 0.1Co—0.4La | | | | | | | | | | |
| | 5 | Fe—12.4Nd—6.3B— | 310.3 | 1.34 | 0.99 | 156.7 | 0.98 | 0.98 | 6.9 | 11.8 | 17.2 | La₈₀Co₂₀Hx |
| | | 0.3Ga—0.2Nb— | | | | | | | | | | |
| | | 0.01La | | | | | | | | | | |
| Com- | C1 | Fe—12.1Nd—6.1B— | 222.7 | 1.10 | 0.43 | 115.4 | 0.81 | 0.42 | 13.4 | 20.5 | — | La₈₀Co₂₀Hx |
| parison | | 0.3Ga—0.2Nb— | | | | | | | | | | |
| | | 0.2Co—2.8La | | | | | | | | | | |
| Exam- | C2 | Fe—12.7Nd—6.2B— | 79.5 | 0.82 | 0.26 | 46.2 | 0.67 | 0.25 | — | — | — | La₈₀Co₂₀Hx |
| ple | | 0.3Ga—0.2Nb— | | | | | | | | | | |
| | | 0.1Co—0.4La | | | | | | | | | | |
| | C3 | Fe—12.5Nd—6.2B— | 310.3 | 1.34 | 0.97 | 161.6 | 0.99 | 0.96 | 8.5 | 19.7 | 30.5 | None |
| | | 0.3Ga—0.2Nb | | | | | | | | | | |

TABLE 2

| | | | | | | Anisotrpic bonded magnet | | | | | | |
|---|---|---|---|---|---|---|---|---|---|---|---|---|
| | | Anisotrpic magnet powder | | | | | | | Permanent demagnetization | | | Utilized |
| | | | Mgnetic properties | | | Mgnetic properties | | | ratio (%) | | | La-type |
| Sample | | Terminal composition | (BH)max | Br | iHc | (BH)max | Br | iHc | 353K × | 373K × | 393K × | magnet |
| No. | | (at %) | (kJm.³) | (T) | (MAm.¹) | (kJm.³) | (T) | (MAm.¹) | 1000 hr | 1000 hr | 1000 hr | powder |
| Exam- | 6 | Fe—12.1Nd—9.0B—0.4Ga— | 286.4 | 1.30 | 0.97 | 144.1 | 0.91 | 0.95 | 5.5 | 9.9 | 15.9 | La₈₀Co₂₀Hx |
| ple | | 0.1Nb—0.1Co—0.2La | | | | | | | | | | |
| Com- | C4 | Fe—12.0Nd—9.0B— | 294.3 | 1.31 | 1.00 | 149.6 | 0.93 | 0.98 | 7.4 | 18.5 | 27.7 | None |
| parison | | 0.4Ga—0.1Nb | | | | | | | | | | |
| Exam- | | | | | | | | | | | | |
| ple | | | | | | | | | | | | |

TABLE 3

| | | | | | | Anisotrpic bonded magnet | | | | | | |
|---|---|---|---|---|---|---|---|---|---|---|---|---|
| | | Anisotrpic magnet powder | | | | | | | Permanent demagnetization | | | Utilized |
| | | | Mgnetic properties | | | Mgnetic properties | | | ratio (%) | | | La-type |
| Sample | | Terminal composition | (BH)max | Br | iHc | (BH)max | Br | iHc | 353K × | 373K × | 393K × | magnet |
| No. | | (at %) | (kJm.³) | (T) | (MAm.¹) | (kJm.³) | (T) | (MAm.¹) | 1000 hr | 1000 hr | 1000 hr | powder |
| Exam- | 7 | Fe—12.5Nd—6.4B—0.3Ga— | 302.0 | 1.32 | 0.92 | 152.8 | 0.95 | 0.90 | 6.3 | 10.4 | 18.3 | Added to the |
| ple | | 0.3Nb—0.4La | | | | | | | | | | raw material |
| | | | | | | | | | | | | alloy |
| Com- | C5 | Fe—12.5Nd—6.4B— | 303.0 | 1.33 | 0.99 | 157.6 | 0.98 | 0.98 | 8.7 | 18.9 | 29.6 | None |
| parison | | 0.3Ga—0.2Nb | | | | | | | | | | |
| Exam- | | | | | | | | | | | | |
| ple | | | | | | | | | | | | |

TABLE 4

| | Isotrpic bonded magnet | | |
|---|---|---|---|
| Isotrpic magnet powder | | Permanent demagnetization | Utilized |

| | | | |
|---|---|---|---|
| Mgnetic properties | Mgnetic properties | ratio (%) | La-type |

| Sample | | Terminal composition | (BH)max | Br | iHc | (BH)max | Br | iHc | 353K × | 373K × | 393K × | magnet |
|---|---|---|---|---|---|---|---|---|---|---|---|---|
| No. | | (at %) | (kJm.³) | (T) | (MAm.¹) | (kJm.³) | (T) | (MAm.¹) | 1000 hr | 1000 hr | 1000 hr | powder |
| Exam- | 8 | Fe—12.1Nd—6.2B— | 115.0 | 0.78 | 1.36 | 80.4 | 0.65 | 1.35 | 1.8 | 3.7 | 6.8 | (La₅₀Dy₅₀)₈₀Co₂₀Hx |
| ple | | 0.3Ga—0.2Nb— | | | | | | | | | | |
| | | 0.1Co—0.4La—0.4Dy | | | | | | | | | | |
| Com- | C6 | Fe—12.5Nd—6.4B— | 117.0 | 0.77 | 1.39 | 83.6 | 0.68 | 1.39 | 5.2 | 9.7 | 12.5 | None |
| parison | | 0.3Ga—0.2Nb | | | | | | | | | | (HDDR [symbol] ) |
| Exam- | | | | | | | | | | | | |
| ple | | | | | | | | | | | | |
| Refer- | | Fe—12.5Nd—6.4B— | 111.0 | 0.85 | 0.76 | 77.2 | 0.68 | 0.76 | 2.0 | 4.0 | 7.0 | None |
| ence | | 0.3Ga—0.2Nb | | | | | | | | | | (quenching |
| Sample | | | | | | | | | | | | sodification |
| | | | | | | | | | | | | method) |

1. An alloy for bonded magnet which includes at least Fe as a main component, 11-15 at % of rare earth element (hereafter referred to as [R]) that includes yttrium (Y) and does not include lanthanum (La), 5.5-10.8 at % of B and 0.01-1.0 at % of La, and has superior corrosion resistance.

2. An alloy for bonded magnet according to claim 1 which includes 0.05-1 at % of gallium (Ga) and 0.05-0.8 at % of niobium (Nb).

3. An alloy for bonded magnet according to claim 1 in which R is composed at least one of Nd, Pr and Dy.

4. Additionally, an alloy for bonded magnet according to claim 1 which includes 0.1-10 at % of cobalt (Co).

5. An isotropic magnet powder obtained by the HDDR process which includes putting an ingot, with alloy composition of at least the main component Fe, R including Y without La of 11-15 at %, B of 5.5-10.8 at % and La of 0.01-1.0 at %, through the hydrogenation step while maintaining the ingot between 1023-1173 K in a hydrogen atmosphere, and then after the hydrogenation step, carrying out the desorption step where hydrogen is removed, is used for bonded magnet with superior corrosion resistance.

6. An isotropic magnet powder obtained from the production method which includes the HDDR process which includes putting a magnet alloy, with alloy composition of at least the main component Fe, R including Y without La as well as B, through the hydrogenation step while maintaining the alloy between 1023-1173 K in a hydrogen atmosphere, and then after the hydrogenation step, carrying out the desorption step where hydrogen is removed, to which diffusion heat process is annexed or unified where a La blended powder that can be obtained by blending the obtained RFeB-type powder after the hydrogenation process or the dehydrogenation process with La-type powder composed of more than one kind that includes a simple substance of La, a La alloy, a La compound and their hydride (a simple substance of La, a La alloy as well as a hydride of La compound, hereafter referred as to La hydride), is heated at 673-1123 K and La is diffused on the surface and the inside of the RFeB-type powder, and when regarding the whole as 100 at %, it includes at least 11-15 at % of the above-mentioned R, 5.5-10.8 at % of the above-mentioned B as well as 0.01-1 at % of the above-mentioned La, and is used for bonded magnet with superior corrosion resistance.

7. An anisotropic magnet powder obtained by the d-HDDR process which includes putting an ingot, with alloy composition of at least the main component Fe, R including Y without La of 11-15 at %, B of 5.5-10.8 at %, and La of 0.01-1.0 at %, through the low temperature hydrogenation step while maintaining the ingot at less than 873 K in a hydrogen atmosphere, and then after the low-temperature hydrogenation step, carrying out the high-temperature hydrogenation step while maintaining 20-100 kPa and 1023-1173 K in a hydrogen atmosphere, and then the high-temperature hydrogenation step, carrying out the first evacuation step while maintaining 0.1-20 kPa and 1023-1173 K in a hydrogen atmosphere, and after the first evacuation step, carrying out the second evacuation step where the hydrogen is removed, is used for bonded magnet with superior corrosion resistance.

8. An anisotropic magnet powder obtained from the production method which includes the d-HDDR process which includes putting a magnet alloy for bonded magnet, with alloy composition of at least the main component Fe, R including Y without La as well as B, through the low temperature hydrogenation step while maintaining the ingot at less than 873 K in a hydrogen atmosphere, and then after the low-temperature hydrogenation step, carrying out the high-temperature hydrogenation step while maintaining 20-100 kPa and 1023-1173 K in a hydrogen atmosphere, and then the high-temperature hydrogenation step, carrying out the first evacuation step while maintaining 0.1-20 kPa and 1023-1173 K in a hydrogen atmosphere, and after the first evacuation step, carrying out the second evacuation step where the hydrogen is removed, to which diffusion heat process is annexed or unified where a La blended powder that can be obtained by blending the obtained RFeB-type powder after the high-temperature, the first evacuation process or the second evacuation process with La-type powder composed of more than one kind that includes a simple substance of La, a La alloy, a La compound and a La hydride, is heated at 673-1123 K and La is diffused on the surface and the inside of the RFeB-type powder, and when regarding the whole as 100 at %, it includes at least 11-15 at % of the above-mentioned R, 5.5-10.8 at % of the above-mentioned B as well as 0.01-1 at % of the above-mentioned La, and is used for bonded magnet with superior corrosion resistance.

9. An isotropic magnet powder obtained from the production method which includes the HDDR process which includes putting a magnet alloy for bonded magnet, with alloy composition of at least the main component Fe, R including Y without La as well as B, through the low temperature hydrogenation step while maintaining the ingot at less than 1023-1173 K in a hydrogen atmosphere, and then after the low-temperature hydrogenation step, carrying out the desorption step where hydrogen is removed, to which diffusion heat process is annexed or unified where a La blended powder that can be obtained by blending the obtained RFeB-type powder after the hydrogenation step and the desorptin step with La-type powder composed of more than one kind that includes a simple substance of La, a La alloy, a La compound and a La hydride, is heated at 673-1123 K and La is diffused on the surface and the inside of the RFeB-type powder, and when regarding the whole as 100 at %, it includes at least 11-15 at % of the above-mentioned R, 5.5-10.8 at % of the above-mentioned B as well as 0.01-1 at % of the above-mentioned La, and is used for bonded magnet with superior corrosion resistance.

10. Production method of an anisotropic magnet powder obtained from the production method which includes the d-HDDR process which includes putting a magnet alloy for bonded magnet, with alloy composition of at least the main component Fe, R including Y without La as well as B, through the low temperature hydrogenation step while maintaining the ingot at less than 873 K in a hydrogen atmosphere, and then after the low-temperature hydrogenation step, carrying out the high-temperature hydrogenation step while maintaining 20-100 kPa and 1023-1173 K in a hydrogen atmosphere, and then the high-temperature hydrogenation step, carrying out the first evacuation step while maintaining 0.1-20 kPa and 1023-1173 K in a hydrogen atmosphere, and after the first evacuation step, carrying out the second evacuation step where the hydrogen is removed, to which diffusion heat process is annexed or unified where a La blended powder that can be obtained by blending the obtained RFeB-type powder after the high-temperature, the first evacuation process or the second evacuation process with La-type powder composed of more than one kind that includes a simple substance of La, a La alloy, a La compound and a La hydride, is heated at 673-1123 K and La is diffused on the surface and the inside of the RFeB-type powder, and when regarding the whole as 100 at %, it includes at least 11-15 at % of the above-mentioned R, 5.5-10.8 at % of the above-mentioned B as well as 0.01-1 at % of the above-mentioned La, and is used for bonded magnet with superior corrosion resistance.

11. A bonded magnet having superior corrosion resistance which can be achieved by mixing binder with the obtained isotropic magnet powder through the HDDR process that is composed of at least the main component Fe, 11-15 at % of R including Y without La, 5.5-10.8 at % of B as well as 0.01-1.0 at % of La, and then by compression molding.

12. A bonded magnet having its superior corrosion resistance which can be achieved by mixing binder with the obtained anisotropic magnet powder through the d-HDDR process that is composed of at least the main component Fe, 11-15 at % of R including Y without La, 5.5-10.8 at % of B as well as 0.01-1.0 at % of La, and then by compression molding.
